(19) United States
(12) Patent Application Publication
(10) Pub. No.: US 2009/0003158 A1
(43) Pub. Date: Jan. 1, 2009

(54) Writing method for optical disk drive

(75) Inventors: Miller Yang, Taoyuan (TW); Shih-Jung Huang, Taoyuan (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan (TW)

(21) Appl. No.: 12/003,987

(22) Filed: Jan. 4, 2008

(30) Foreign Application Priority Data
Jun. 26, 2007 (TW) 96123224

(51) Int. Cl. G11B 5/09

(52) U.S. Cl. 369/47.15

(57) ABSTRACT

A writing method for an optical disk drive includes the following steps. First, a write command and to-be-written data are received from a host. Next, a speed down flag is checked. If the speed down flag is true, a writing speed is decreased; or otherwise the to-be-written data is written into a data area. Next, the written data is read, and accuracy of the written data is verified. If the written data is not accurate, accurate data is re-written into a spare area, and the number of times of re-writing is counted and checked. If the number of times of re-writing is greater than a predetermined threshold value, the speed down flag is changed to true; or otherwise the procedure goes back to the data-writing step to repeat the above-mentioned steps. If the written data is read and verified as accurate, a write-end status is reported back to the host.

This application claims the benefit of Taiwan application Serial No. 96123224, filed Jun. 26, 2007, the subject matter of which is incorporated herein by reference.

### BACKGROUND OF THE INVENTION

1. Field of the Invention

The invention relates in general to a writing method for an optical disk drive, and more particularly to a method of speeding down a writing speed of an optical disk drive according to a writing quality.

2. Description of the Related Art

Optical disk drives have properties differing from one another, and tend to generate different writing qualities according to a command of a host and to-be-written data in the same condition. The writing qualities thereof also differ from one another, and the variations thereof are very great. The poor writing quality causes the optical disk drive to spend a longer period of time to correct the error, thereby decreasing the overall efficiency or disabling the written data from being read, and thus influencing the quality of the optical disk drive.

In order to ensure the written data to be accurate, the DVD-RAM type optical disk drive has a verifying mechanism. FIG. 1 (Prior Art) is a flow chart showing a writing method for a DVD-RAM type optical disk drive according to the prior art. First, the DVD-RAM type optical disk drive receives a write command and to-be-written data transmitted from a host in step P1, and then writes the to-be-written data into a data area of an optical disk in step P2 according to the write command. After the data has been completely written, the procedure enters step P3, in which the optical disk drive reads the written data, and then enters step P4 to verify whether the written data read by the optical disk drive is accurate or not according to the order of reading the data. If not, which means that the to-be-written data transmitted from the host is different from the written data read by the optical disk drive, the procedure enters step P5 to re-write the accurate data, corresponding to the inaccurate data, into a spare area of the optical disk, a defect list is updated to mark the data re-writing position, and the defect list is temporarily stored in a DRAM of the optical disk drive. Then, the procedure goes back to the step P3 to repeat the operation of reading the written data. If it is verified that the written data, which is read by the optical disk drive, is accurate in the step P4, the procedure enters step P6 to check whether a defect managing area has to be updated. If no defect is detected in the written data, which is completely accurate, the procedure enters step P8. If the DRAM of the optical disk drive has the updated defect list, the procedure enters step P7 to write the updated defect list in the DRAM of the optical disk drive into the defect managing area of the optical disk. Finally, the procedure enters the step P8 to report a write-end status back to the host so that the data can be subsequently written at the next time.

The DVD-RAM type optical disk drive immediately reads the written data to verify whether the written data is accurate after the data has been written, and performs the defect management on the inaccurate written data. However, the optical disk drive is not adjusted. If the optical disk drive has the poor writing quality, many defects are found and the data is re-written into the spare area, the next time of data writing still can generate many defects. Similarly, the writing quality is poor, and it is time-consuming to improve the defects, which is not advantageous to the overall efficiency of the optical disk drive. Therefore, the conventional optical disk drive still has some problems to be overcome in the writing method.

### SUMMARY OF THE INVENTION

The invention is directed to a writing method for an optical disk drive, wherein a writing condition of the optical disk drive is adjusted by verifying whether the written data is accurate so that the variations of the optical disk drives can be effectively overcome.

The invention is also directed to a writing method for an optical disk drive, wherein a writing speed is decreased to enhance the writing quality when the number of times of re-writing data is greater than a predetermined threshold value.

The invention is further directed to a writing method for an optical disk drive, wherein the condition, in which the writing speed of the optical disk drive has to be decreased, is accurately evaluated to prevent the writing speed from being incorrectly decreased and to keep the overall writing efficiency.

According to the present invention, a writing method for an optical disk drive is provided. The method includes the following steps. First, a write command and to-be-written data are received from a host. Next, a speed down flag is checked. If the speed down flag is true, a writing speed is decreased; or otherwise the to-be-written data is written into a data area. Next, the written data is read, and accuracy of the written data is verified. If the written data is not accurate, accurate data is re-written into a spare area, a defect list is updated and temporarily stored in a DRAM of the optical disk drive, and the number of times of re-writing is counted and checked whether it is greater than a predetermined threshold value. If the number of times of re-writing is greater than the predetermined threshold value, the speed down flag is changed to true; or otherwise the procedure goes back to the data-writing step to repeat the above-mentioned steps. If the written data is read and verified as accurate, a write-end status is reported back to the host.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a flow chart showing a writing method for an optical disk drive according to the prior art.

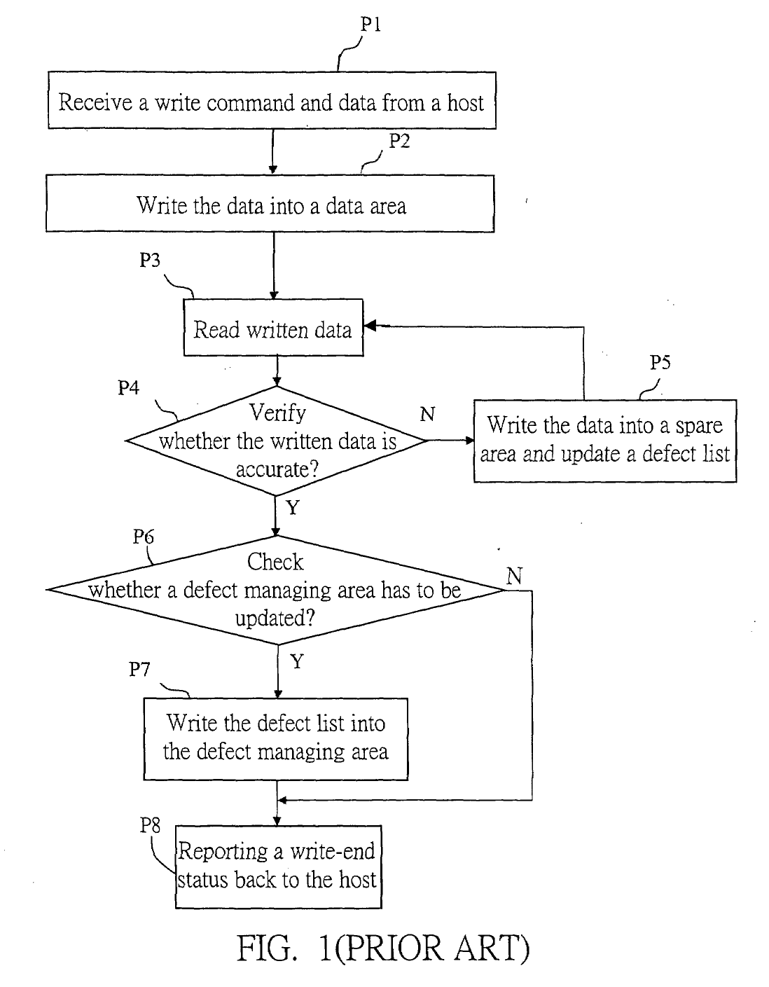

FIG. 2 is a flow chart showing a writing method for an optical disk drive according to the invention.

### DETAILED DESCRIPTION OF THE INVENTION

The DVD-RAM type optical disk drive actively reads a piece of written data after the piece of written data has been written to verify whether the data has been accurately written. The inaccurately written data is managed as a defect. That is, the accurate data is re-written into a spare area of an optical disk to replace the inaccurate data. The writing method for the optical disk drive according to the invention utilizes the DVD-RAM type optical disk drive to write the data and conduct the defect managing mechanism. When the DVD-RAM type optical disk drive is verifying the writing accuracy, the DVD-RAM type optical disk drive finds that the written data is inaccurate, and thus counts the number of times of re-writing and gives a suitable threshold value of the number of times, such as 8. As long as the number of times of re-writing in the DVD-RAM type optical disk drive exceeds the threshold value, it is judged that the DVD-RAM type optical disk drive may have the poor data writing quality according to the current writing speed. Thus, a writing speed flag of the optical disk drive is changed so that the optical disk drive decreases the writing speed according to the changed writing speed flag before receiving a command from a host to write the data at the next time so that the optical disk drive obtains the better writing quality at the lower writing speed. Consequently, when the DVD-RAM type optical disk drive is verifying the accuracy of the written data, the number of errors can be decreased, the time of re-writing can be shortened, and the variations of the optical disk drives can be corrected.

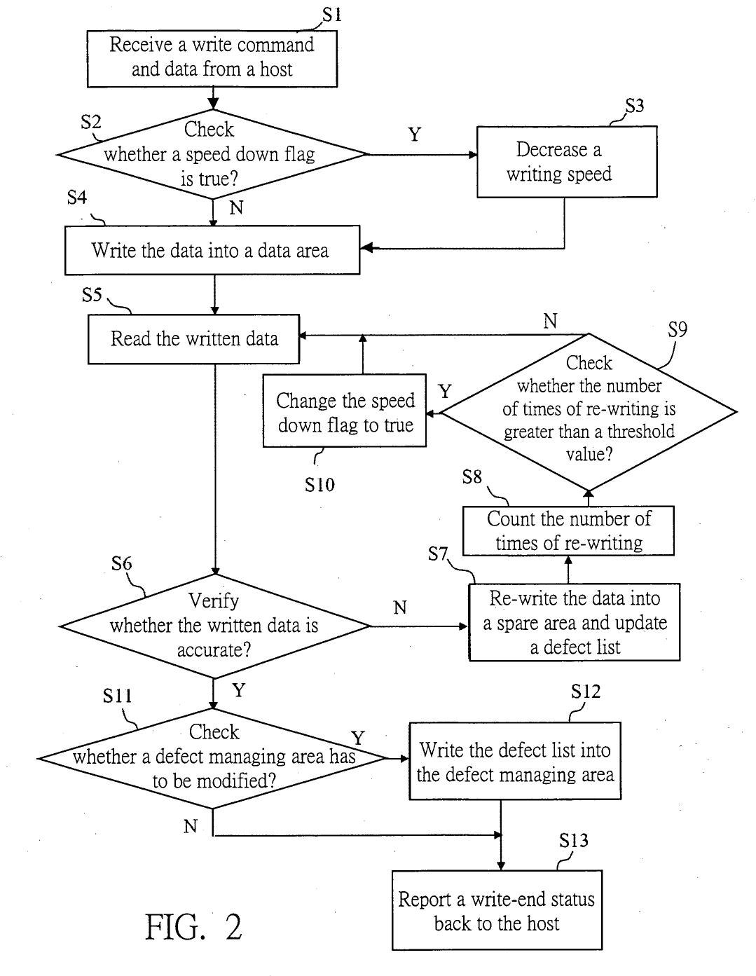

FIG. 2 is a flow chart showing a writing method for an optical disk drive according to the invention. Referring to FIG. 2, the method of the invention is to count the number of times of re-writing according to the property that the DVD-RAM type optical disk drive will re-write when data is poorly written so that the writing speed can be decreased. The detailed steps will be described in the following.

In step S1, the optical disk drive firstly receives a write command and to-be-written data transmitted from a host, and thus starts the writing operation.

In step S2, it is checked whether a speed down flag is true. The data is written according to the high speed or the low speed selected according to the variations of the optical disk drives. If the speed down flag is true, the procedure enters step S3, or otherwise the procedure enters step S4.

In the step S3, if the speed down flag is true, the optical disk drive decreases the writing speed to a predetermined speed, and then the procedure enters the step S4.

In the step S4, if the speed down flag is false or the optical disk drive has been speeded down to the predetermined speed, the to-be-written data is written into a data area of an optical disk according to the write command. The procedure enters step S5 after the data is completely written.

In the step S5, the optical disk drive reads the piece of written data so that the writing quality can be verified.

In step S6, it is verified whether the written data read by the optical disk drive is accurate according to the order of reading the data. That is, it is verified whether the to-be-written data of the host matches with the written data. If they do not match with each other, the written data is inaccurate and the procedure enters step S7. If it is verified that the written data, which is read by the optical disk drive, is accurate, the procedure enters step S11.

In the step S7, if the written data is not accurate, the accurate data, corresponding to the inaccurate data, is re-written into a spare area of the optical disk, and the defect list is updated to mark the data re-writing position. The defect list is temporarily recorded in a DRAM of the optical disk drive, and then the procedure enters the next step.

In step S8, the number of times of re-writing is accumulated and counted by adding 1 to the previous number of times of re-writing, and the procedure enters the next step.

In step S9, whether the writing quality of the optical disk drive reaches the required level is checked by checking whether the number of times of re-writing is greater than a predetermined threshold value. If the number of times of re-writing is greater than the predetermined threshold value, the procedure enters step S10; or otherwise the procedure goes back to the step S5 to repeat the writing step.

In the step S10, if the number of times of re-writing is greater than the predetermined threshold value, it means that the optical disk drive has the poor quality when writing data at the high speed. Thus, the speed down flag of the optical disk drive is changed to true so that the writing speed can be decreased at the next time of writing.

In the step S11, if the written data read by the optical disk drive is verified as accurate in the step S6, it is further checked whether a defect managing area has to be updated. If no defect has been detected in the piece of written data, which is completely accurate, the procedure enters step S13. If the DRAM of the optical disk drive has the updated defect list, the procedure enters step S12.

In the step S12, the updated defect list in the DRAM of the optical disk drive is written into the defect managing area of the optical disk, and then the procedure enters the step S13.

In the step S13, a write-end status is reported back to the host so that the data can be subsequently written conveniently.

Therefore, the writing method for the optical disk drive according to the invention can decrease the writing speed and thus adjust the suitable writing condition for each optical disk drive by counting the number of times of re-writing the data and determining whether the number of times of re-writing the data exceeds the predetermined threshold value according to the property of verifying whether the written data of the DVD-RAM type optical disk drive is accurate so that the variations of the optical disk drives can be effectively overcome. Meanwhile, evaluating the actual writing quality of the optical disk drive can accurately judge the condition of whether the writing speed of the optical disk drive has to be decreased. Thus, it is possible to prevent the writing speed from being incorrectly decreased, the writing quality can be enhanced, and the overall writing efficiency can be kept.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A writing method for an optical disk drive, the method comprising the steps of:
(1) receiving a write command and to-be-written data from a host;
(2) checking whether a speed down flag is true or not, and entering step (3) if the speed down flag is true or otherwise entering step (4);
(3) speeding down a writing speed;
(4) writing the to-be-written data into a data area;
(5) reading the written data;
(6) verifying whether the written data is accurate, and entering step (11) if the written data is accurate or otherwise entering step (7);
(7) re-writing accurate data into a spare area;
(8) counting the number of times of re-writing;
(9) checking whether the number of times of re-writing is greater than a predetermined threshold value, and entering step (10) if the number of times of re-writing is greater than the predetermined threshold value, or otherwise going back to step (5);
(10) changing the speed down flag to true; and
(11) reporting a write-end status back to the host.

2. The method according to claim 1, wherein the step (3) decreases the writing speed to a predetermined speed.

3. The method according to claim 1, wherein the step (6) verifies whether the written data, which is read, matches with the to-be-written data, which is transmitted from the host, and the written data is verified as accurate if they matches with each other, or otherwise the written data is verified as inaccurate.

4. The method according to claim 1, wherein the threshold value in the step (9) is set in advance.

5. The method according to claim 4, wherein the threshold value is equal to 8.

6. The method according to claim 1, wherein a defect list is updated to mark a data re-writing position after the step (7) of re-writing.

7. The method according to claim 6, wherein the defect list is temporarily recorded in a DRAM of the optical disk drive.

8. The method according to claim 6, further comprising, after the step (10) of changing the speed down flag to true, the steps of:
(10a) checking whether a defect managing area has to be updated or not, and entering the step (11) if the written data is accurate, or entering the next step if the defect list is updated; and
(10b) writing the updated defect list into the defect managing area.

9. The method according to claim 8, wherein the defect managing area is located on an optical disk.
